(19) United States
(12) Patent Application Publication
(10) Pub. No.: US 2023/0169114 A1
(43) Pub. Date: Jun. 1, 2023

(54) AD HOC PROCESSING OF GRAPH DATA

(71) Applicant: SAP SE, Walldorf (DE)

(72) Inventors: Markus Fath, Wiesloch (DE); Hannes Jakschitsch, Mannheim (DE); Roland Sedler, Dossenheim (DE)

(21) Appl. No.: 17/536,923

(22) Filed: Nov. 29, 2021

(51) Int. Cl. G06F 16/901; G06F 16/242

(52) U.S. Cl. CPC G06F 16/9024; G06F 16/2433

(57) ABSTRACT

A method for ad hoc graph data processing may include receiving, from a client device, a graph processing algorithm defined as a part of an anonymous block. The anonymous block may be a data manipulation language (DML) statement containing the graph processing algorithm. The anonymous block may be compiled. The graph progressing algorithm included in the anonymous block may be executed on at least a portion of a graph data stored in a database. The anonymous block being compiled and executed without generating a database object corresponding to the anonymous block at the database. Related systems and computer program products are also provided.

### TECHNICAL FIELD

The subject matter described herein relates generally to database processing and more specifically to ad hoc processing of graph data.

### BACKGROUND

A database may be configured to store data in accordance with a database schema. For example, in a graph database, data may be represented and stored using graph structures including, for example, vertices, directed edges, undirected edges, and/or the like. Notably, the graph database may store the relationships between different data items explicitly. For instance, the vertices of a graph may correspond to the individual data items stored in the graph database while the edges of the graph may define the relationships between these data items. Attributes associated with the vertices and/or the edges may provide additional properties for the data items stored in the graph database and/or the relationships that exist between different data items. Contrastingly, a relational database may store the relationships between different data items implicitly, for example, by organizing the data items into one or more database tables. A relational database may be configured to store graph data, for example, by storing the vertices of a graph in a vertex table and the edges of the graph in a separate edge table.

### SUMMARY

Systems, methods, and articles of manufacture, including computer program products, are provided for ad hoc processing of graph data. In one aspect, there is provided a system including at least one data processor and at least one memory. The at least one memory may store instructions that cause operations when executed by the at least one data processor. The operations may include: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

In some variations, one or more features disclosed herein including the following features can optionally be included in any feasible combination. The anonymous block may be defined to include one or more input parameters. Each input parameter may be initialized with a scalar expression or a prepared parameter whose value is provided at an execution time of the anonymous block.

In some variations, the anonymous block may be further defined to include one or more output parameters. Each output parameter may be initialized as a prepared parameter whose value is dependent on the executing of the anonymous block.

In some variations, at least one input parameter or output parameter of the anonymous block may be defined to have a structured query language (SQL) data type comprising an integer, a bigint, a double, a Boolean, an nvarchar, or a timestamp.

In some variations, at least one input parameter or output parameter of the anonymous block may be defined as a table parameter including one or more columns, and wherein each column may be defined to have a structured query language (SQL) data type comprising an integer, a bigint, a double, a Boolean, an nvarchar, or a timestamp.

In some variations, the operations may further include: determining that an end user associated with the client device is authorized to access one or more graph workspaces used by the anonymous block to perform the graph processing algorithm; and in response to determining that the end user associated with the client device is authorized to access the one or more graph workspaces, executing the graph processing algorithm included in the anonymous block.

In some variations, the operations may further include: generating, for display at the client device, an error message in response to determining that the end user associated with the client device is not authorized to access the one or more graph workspaces used by the anonymous block to perform the graph processing algorithm.

In some variations, the anonymous block may include a data manipulation language (DML) statement containing the graph processing algorithm.

In some variations, the graph processing algorithm may include one or more graph processing functions including subgraph, inverse graph, in-degree, out-degree, incoming edges, outgoing edges, neighbors, is-reachable, shortest path, shortest path one to all, k shortest paths, strongly connected components, depth first traversal, and breadth first traversal.

In some variations, the anonymous block may be compiled a single time but executed a first time based on a first value of an input parameter provided at execution and a second time based on a second value of the input parameter provided at execution.

In another aspect, there is provided a method for ad hoc processing of graph data. The method may include: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

In some variations, one or more features disclosed herein including the following features can optionally be included in any feasible combination. The anonymous block may be defined to include one or more input parameters. Each input parameter may be initialized with a scalar expression or a prepared parameter whose value is provided at an execution time of the anonymous block.

In some variations, the anonymous block may be further defined to include one or more output parameters. Each output parameter may be initialized as a prepared parameter whose value is dependent on the executing of the anonymous block.

In some variations, at least one input parameter or output parameter of the anonymous block may be defined to have a structured query language (SQL) data type comprising an integer, a bigint, a double, a Boolean, an nvarchar, or a timestamp.

In some variations, at least one input parameter or output parameter of the anonymous block may be defined as a table parameter including one or more columns, and wherein each column may be defined to have a structured query language (SQL) data type comprising an integer, a bigint, a double, a Boolean, an nvarchar, or a timestamp.

In some variations, the method may further include: determining that an end user associated with the client device is authorized to access one or more graph workspaces used by the anonymous block to perform the graph processing algorithm; and in response to determining that the end user associated with the client device is authorized to access the one or more graph workspaces, executing the graph processing algorithm included in the anonymous block.

In some variations, the method may further include: generating, for display at the client device, an error message in response to determining that the end user associated with the client device is not authorized to access the one or more graph workspaces used by the anonymous block to perform the graph processing algorithm.

In some variations, the anonymous block may include a data manipulation language (DML) statement containing the graph processing algorithm.

In some variations, the anonymous block may be compiled a single time but executed a first time based on a first value of an input parameter provided at execution and a second time based on a second value of the input parameter provided at execution.

In another aspect, there is provided a computer program product including a non-transitory computer readable medium storing instructions. The instructions may cause operations may executed by at least one data processor. The operations may include: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

Implementations of the current subject matter can include, but are not limited to, methods consistent with the descriptions provided herein as well as articles that comprise a tangibly embodied machine-readable medium operable to cause one or more machines (e.g., computers, etc.) to result in operations implementing one or more of the described features. Similarly, computer systems are also described that may include one or more processors and one or more memories coupled to the one or more processors. A memory, which can include a non-transitory computer-readable or machine-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including, for example, to a connection over a network (e.g. the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to the processing of graph data, it should be readily understood that such features are not intended to be limiting. The claims that follow this disclosure are intended to define the scope of the protected subject matter.

### DESCRIPTION OF DRAWINGS

The accompanying drawings, which are incorporated in and constitute a part of this specification, show certain aspects of the subject matter disclosed herein and, together with the description, help explain some of the principles associated with the disclosed implementations. In the drawings,

FIG. 1 depicts a system diagram illustrating an example of a graph data processing system, in accordance with some example embodiments;

FIG. 2 depicts an example of graph data, in accordance with some example embodiments;

FIG. 3 depicts a flowchart illustrating an example of a process for ad hoc graph data processing, in accordance with some example embodiments; and

FIG. 4 depicts a block diagram illustrating an example of a computing system, in accordance with some example embodiments.

When practical, similar reference numbers denote similar structures, features, or elements.

### DETAILED DESCRIPTION

A database storing graph data may support graph processing algorithms including, for example, shortest path, risk propagation, minimum flow, page rank, and/or the like. Graph data processing in a conventional database may require the definition of one or more stored procedures. For example, a relational database may store the vertex table and the edge table of a graph in a corresponding graph workspace while the graph algorithms operating on the graph may be defined as stored procedures. The graph workspace and each stored procedure may be separate database objects registered in the metadata catalog associated with the relational database. As such, a stored procedure that is no longer in use should be deleted. Meanwhile, changes to the signatures (e.g., parameters) and/or processing logic of an existing stored procedure necessitates the creation of a new stored procedure and/or the replacement of the existing stored procedure. However, the creation, replacement, and deletion of stored procedures are computationally expensive operations that require an analysis of the dependencies between the different database objects. Graph data processing in a conventional database is therefore complicated by the task of managing the lifecycle of stored procedures.

Implementing graph processing algorithms as stored procedures also imposes computational limitations because stored procedures are typically defined in a statically typed language (e.g. GraphScript and/or the like). As such, the data type of all the instantiated objects must be known when a stored procedure is created (e.g., compiled). Moreover, the data type of these objects must remain the same for the lifetime of the stored procedure. In practice, the metadata (e.g., name and data type) of all vertices and edges used in the stored procedure must be known at the time the stored procedure is compiled. In order to achieve this, a graph constructor expects structured query language (SQL) identifiers (e.g., constants) as arguments. Although a graph workspace is uniquely identified by a schema name and a workspace name, a graph object cannot be created based on the schema name and workspace name provided as input parameters during the execution and/or runtime of the stored procedure because the values of such input parameters are only known when the stored procedure is executed. Accordingly, a stored procedure cannot be parametrized with a graph workspace. While it may be possible to provide a table as an input parameter to a stored procedure, a graph workspace may not be provided as an input parameter to a stored procedure. A conventional database lacks a data type capable of modeling a graph workspace.

Because a stored procedure cannot be parameterized with a graph workspace, a single stored procedure cannot be used across multiple graph workspaces. Instead, a separate stored procedure must be created for each graph workspace. This is true even if the stored procedures implement the same graph data processing logic and operate on graph data (e.g., vertices and edges) having the same metadata (e.g., attribute name and type). However, as noted, managing the lifecycle of stored procedure is a complicated task because the creation, replacement, and deletion of stored procedures are computationally expensive operations that require an analysis of the dependencies between the different database objects. Thus, creating new stored procedures for each graph workspace may be computationally inefficient, especially for applications that process large quantities of graph workspaces. For example, for each application programing interface (API) call operating on a new graph workspace, a new stored procedure may be created and called before being deleted. As such, in some example embodiments, a calculation engine at a database may perform ad hoc processing on graph data stored in the database by implementing graph processing algorithms as anonymous blocks instead of stored procedures.

Notably, once compiled, a stored procedure may be stored persistently in the metadata catalog of the relational database. Like other objects in the catalog (e.g., tables, views, and/or the like), the stored procedure may be uniquely identified by its schema qualified name. As such, the stored procedure may be invoked through its given schema qualified name. Contrastingly, an anonymous block, which is a “code block without a name,” is executed immediately upon compilation. From the perspective of an end user, the compilation and execution of an anonymous block are performed as a single operation. While a stored procedure may be reused (e.g., by invoking the stored procedure by its schema qualified name), an anonymous block may not be reused. However, the executable code generated for an anonymous block is temporarily stored in a SQL plan cache, which enables the executable code to be re-executed with different input parameter values while the corresponding entry (e.g., in the SQL plan cache) remains valid. Invalidation of an entry corresponding to the anonymous block may occur when the underlying graph data (e.g., vertex table and/or edge table) is altered. A SQL plan can also be evicted from the SQL plan cache based on how often the corresponding SQL queries are used. Nevertheless, from the perspective of the end user, anonymous blocks are not reused but permit a low overhead execution of one-time graph processing logic.

It should be appreciated that anonymous blocks may support the same graph processing algorithms and same data types as stored procedures. For example, the input parameters and output parameters of an anonymous block may be defined as structured query language (SQL) data types including, for example, an integer, a bigint, a double, a Boolean, an nvarchar, a timestamp, and/or the like. Alternatively and/or additionally, the input parameters and output parameters of an anonymous block may be defined as a table parameter in which the columns of the table have a structured query language (SQL) data type (e.g., an integer, a bigint, a double, a Boolean, an nvarchar, a timestamp, and/or the like).

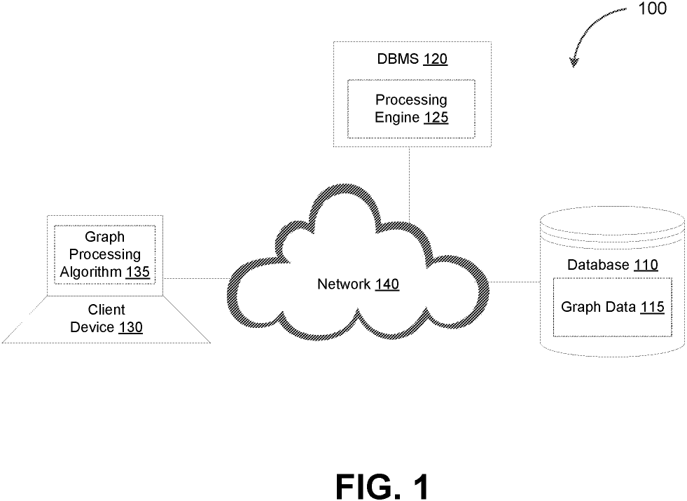

FIG. 1 depicts an example of a graph data processing system 100, in accordance with some example embodiments. Referring to FIG. 1, the graph data processing system 110 may include a database 110 storing a graph data 115, a database management system 120 including a processing engine 125, and a client device 130. The graph database 110, the database management system 120, and the client device 130 may be communicatively coupled via a network 140. In some example embodiments, the database 110 may be a relational database configured to store the graph data 115. However, it should be appreciated that the database 110 may be any type of database including, for example, an in-memory database, a hierarchical database, an object database, an object-relational database, a non-Structured Query Language (NoSQL) database, and/or the like. For example, instead of and/or in addition to being a relational database, the database 115 may be a graph database, a column store, a key-value store, a document store, and/or the like.

The database management system 120 may be configured to respond to requests from one or more client devices including, for example, the client device 130. For example, as shown in FIG. 1, the client device 130 may communicate with the database management system 110 via the network 140, which may be any wired and/or wireless network including, for example, a public land mobile network (PLMN), a wide area network (WAN), a local area network (LAN), a virtual local area network (VLAN), the Internet, and/or the like. The client device 130 may be a processor-based device including, for example, a smartphone, a tablet computer, a wearable apparatus, a virtual assistant, an Internet-of-Things (IoT) appliance, and/or the like.

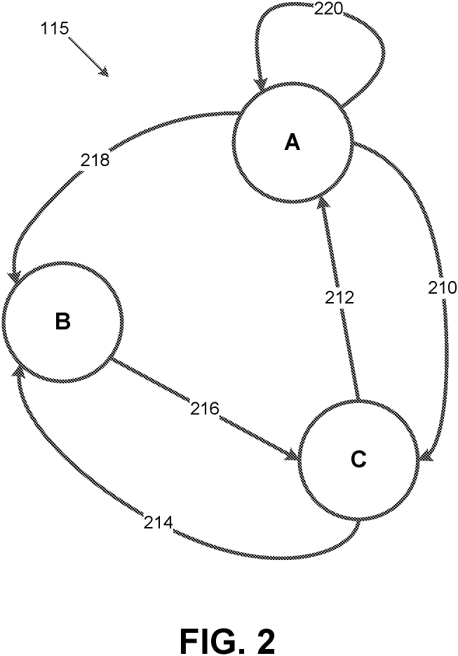

The client device 130 may send, to the database management system 110, a request to execute a graph processing algorithm 135 that derives a solution by operating on the graph data 115 stored in the database 110. To further illustrate, FIG. 2 depicts an example of the graph data 115 stored in the database 115, for example, in a vertex table and an edge table. As shown in FIG. 2, the graph data 200 may include one or more vertices including, for example, a first vertex A, a second vertex B, and a third vertex C. Furthermore, the one or more vertices may be interconnected via one or more edges including, for example, a first edge 210, a second edge 212, a third edge 214, a fourth edge 216, a fifth edge 218, and a sixth edge 220. In the example of the graph data 115 shown in FIG. 2, the one or more edges are directed edges but it should be appreciated that the one or more edges may also be undirected edges interconnecting the one or more vertices.

The graph processing algorithm 135 may include one or more graph processing functions including, for example, subgraph, inverse graph, in-degree, out-degree, incoming edges, outgoing edges, neighbors, is-reachable, shortest path, shortest path one to all, k shortest paths, strongly connected components, depth first traversal, breadth first traversal, and/or the like. In some example embodiments, the graph processing algorithm 135 may be defined as an anonymous block instead of a stored procedure. The anonymous block may be an executable data manipulation statement (DML) containing one or more imperative statements and/or declarative statements forming, for example, a GraphScript program corresponding to the graph processing algorithm 135. Moreover, unlike defining the graph processing algorithm 135 as a stored procedure, defining the graph processing algorithm 135 as an anonymous block does not generate a corresponding database object in the database 110 that is also registered in the metadata catalog of the database 110. Instead, the anonymous block corresponding to the graph processing algorithm 135 may be defined and executed using the example of the syntax shown in Table 1 below.

TABLE 1

DO [(<parameter_clause>)] LANGUAGE GRAPH
BEGIN
<body>
END
<body> ::= !! supports the same feature set as GraphScript procedures

Defining the graph processing algorithm 135 as an anonymous block, which does not generate a corresponding database object at the database 110, obviate the complicated task of lifecycle management associated with defining the graph processing algorithm 135 as a stored procedure. As such, the anonymous block implementing the graph processing algorithm 135 may be defined, compiled, and executed by the processing engine 115 without any subsequent deletion operation to remove the corresponding database object from the database 110 and the metadata catalog of the database 110. Moreover, the anonymous block implementing the graph processing algorithm 135 may be executed without the transfer of any intermediate results between the database management system 120 and the client device 130. Instead, the anonymous block implementing the graph processing algorithm 135 may be compiled and executed (e.g., in a single operation from the perspective of the end user at the client device 130) at the database management system 120 before the final result is returned to the client device 130.

Table 2 below depicts the syntax for an example of an anonymous block implementing, for example, the graph processing algorithm 135.

TABLE 2

DO (
IN START_VERTEX_ID NVARCHAR(10) => ?,
IN DESTINATION_VERTEX_ID NVARCHAR(10) => ?,
OUT DISTANCE BIGINT => ?)
LANGUAGE GRAPH
BEGIN
GRAPH g = GRAPH(“GRAPH _PROCESSING_EXAMPLE”, “EXAMPLE_GRAPH”);
VERTEX v_source = VERTEX(:g, :START_VERTEX_ID);
VERTEX v_destination = VERTEX(:g, :DESTINATION_VERTEX_ID);
WEIGHTEDPATH<BIGINT> p = SHORTEST_PATH(:g, :v_source, :v_destination);
DISTANCE = LENGTH(:p);
END;

In some example embodiments, an anonymous block implemented using GraphScript may be read only because the anonymous block does not modify the graph data 115 stored in the database 110 or its structure. As the example in Table 2 shows, each input parameters of the anonymous block may be initialized with a scalar expression or a prepared parameter (denoted as “?”) whose value is provided at execution time. The output parameters of the anonymous block may be initialized with as prepared parameters (denoted as “?”) whose values are dependent on the execution of the anonymous block. Although the anonymous block is compiled a single time, the anonymous block may be executed more than once with different prepared parameter values provided at execution time. Nevertheless, it should be appreciated that neither the input parameters nor the output parameters of the anonymous block may be initialized as variables whose values are dependent on the execution of another procedure. Moreover, the data type of the input parameters and output parameters of the anonymous block may correspond to the data types supported by GraphScript, which may include, for example, certain SQL data types (e.g., integer, bigint, double, Boolean, nvarchar, and timestamp).

To further illustrate, Table 3 below depicts examples of different parameter clauses initializing the input parameters and/or output parameters of an anonymous block.

TABLE 3

<parameter_clause> ::= <named_parameter> [{,<named_parameter>}...]
<named_parameter> ::= {IN | OUT} <parameter name> <parameter type> =>
<parameter_value>
<parameter_name> ::= <identifier>
<parameter_value> ::= ? | <identifier> | <string_literal> | <unsigned integer> |
<signed integer> | <signed_numeric_literal> | <unsigned_numeric_literal> | <expression>
<parameter type> ::= <scalar_data^{_}type> | <table_type> | <table^{_}type_definition>

Table 4 below depicts different data types for the input parameters and/or output parameters of an anonymous block.

TABLE 4

<scalar_data^{_}type> ::= INTEGER | BIGINT | DOUBLE | BOOLEAN |
NVARCHAR [ (<unsigned integer>) ] | TIMESTAMP
The parameters can have any of the primitive SQL types supported in GraphScript.
<table_type> ::= [<schema_name>.]<identifier>
Specifies a table type that was previously defined with the CREATE TYPE statement.
<table_type_definition> ::= TABLE (<column_list_definition>)
Specifies a table type that is defined within the signature of the procedure.
<column_list_definition> ::= <column_definition> [ { , <column_definition> } [...] ]
<column_definition> ::= <column_name> <scalar_data_type>
<column_name> ::= <identifier>

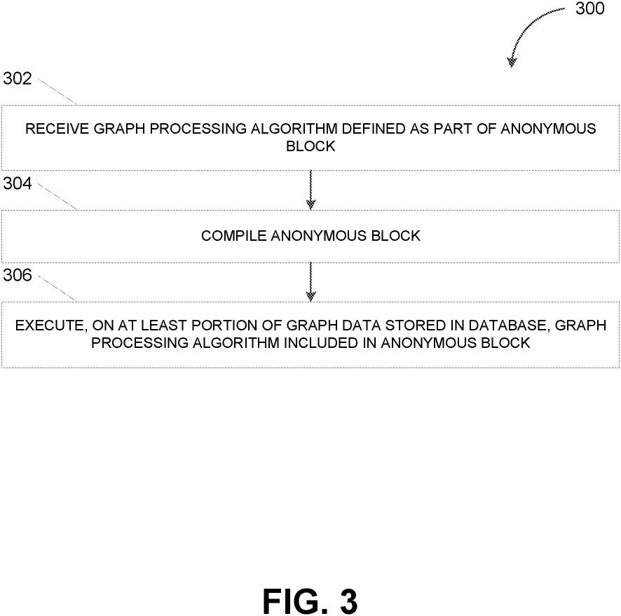

FIG. 3 depicts a flowchart illustrating an example of a process 300 for ad hoc graph data processing, in accordance with some example embodiments. Referring to FIGS. 1-3, the process 300 may be performed by the database management system 120, for example, the processing engine 125, in response to a request from the client device 130 to execute the graph processing algorithm 135 on the graph data 115 stored in the database 110.

At 302, the processing engine 125 may receive a graph processing algorithm defined as a part of an anonymous block. For example, the processing engine 125 may receive, from the client device 130, the graph processing algorithm 135 defined as a part of an anonymous block. The graph processing algorithm 135 may include one or more graph processing functions including, for example, subgraph, inverse graph, in-degree, out-degree, incoming edges, outgoing edges, neighbors, is-reachable, shortest path, shortest path one to all, k shortest paths, strongly connected components, depth first traversal, breadth first traversal, and/or the like. The graph processing algorithm 135 may be defined as an anonymous block instead of a stored procedure to avoid the complicated task of managing the lifecycle of the stored procedure. In particular, the anonymous block implementing the graph processing algorithm 135 may be defined, compiled, and executed by the processing engine 115 without any subsequent deletion operation to remove the corresponding database object from the database 110 and the metadata catalog of the database 110.

At 304, the processing engine 125 may compile the anonymous block. In some example embodiments, the anonymous block implementing the graph processing algorithm 135 may be compiled and executed a single time. In order to be compiled successfully, the input parameters of the anonymous block may be initialized with scalar expressions or a prepared parameter whose value is provided at execution time while the output parameters of the anonymous block may be initialized with as prepared parameters whose values are dependent on the execution of the anonymous block. An anonymous block having any input parameters and/or output parameters whose value depend on the execution of another procedure may fail to successfully compile. During the compilation of the anonymous block, the processing engine 125 may identify the portions of the graph data 115 (e.g., one or more graph workspaces) used by the anonymous block to perform the graph processing algorithm.

At 306, the processing engine 125 may execute, on at least a portion of a graph data stored in a database, the graph processing algorithm included in the anonymous block. In some example embodiments, the processing engine 125 may execute the graph processing algorithm 135 by operating on at least a portion of the graph data 115 stored in the database 110. As noted, even though the anonymous block is compiled a single time, the anonymous block may nevertheless be executed multiple times with different prepared parameter values provided at execution. Nevertheless, the anonymous block is not associated with a name or a corresponding database object in the database 110. As such, the anonymous block implementing the graph processing algorithm 135 cannot be reused by invoking the anonymous block by its name, as would be the case for a stored procedure implementing the graph processing algorithm 135. Between the compilation of the anonymous block and the execution of the anonymous block, the processing engine 125 may perform one or more authorization checks to determine whether the end user is permitted to access the portions of the graph data 115 (e.g., the one or more graph workspaces) used by the anonymous block to perform the graph processing algorithm 135. An error message may be returned (e.g., to the client device 130) if the processing engine 125 determines that the end user is not authorized to access at least one of the graph workspaces used by the anonymous block.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:

Example 1: A system, comprising: at least one data processor; and at least one memory storing instructions, which when executed by the at least one data processor, result in operations comprising: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

Example 2: The system of example 1, wherein the anonymous block is defined to include one or more input parameters, and wherein each input parameter is initialized with a scalar expression or a prepared parameter whose value is provided at an execution time of the anonymous block.

Example 3: The system of any one of examples 1 to 2, wherein the anonymous block is further defined to include one or more output parameters, and wherein each output parameter is initialized as a prepared parameter whose value is dependent on the executing of the anonymous block.

Example 4: The system of any one of examples 1 to 3, wherein at least one input parameter or output parameter of the anonymous block is defined to have a structured query language (SQL) data type comprising an integer, a bigint, a double, a Boolean, an nvarchar, or a timestamp.

Example 5: The system of any one of examples 1 to 4, wherein at least one input parameter or output parameter of the anonymous block is defined as a table parameter including one or more columns, and wherein each column may be defined to have a structured query language (SQL) data type comprising an integer, a bigint, a double, a Boolean, an nvarchar, or a timestamp.

Example 6: The system of any one of examples 1 to 5, wherein the operations further comprise: determining that an end user associated with the client device is authorized to access one or more graph workspaces used by the anonymous block to perform the graph processing algorithm; and in response to determining that the end user associated with the client device is authorized to access the one or more graph workspaces, executing the graph processing algorithm included in the anonymous block.

Example 7: The system of example 6, wherein the operations further comprise: generating, for display at the client device, an error message in response to determining that the end user associated with the client device is not authorized to access the one or more graph workspaces used by the anonymous block to perform the graph processing algorithm.

Example 8: The system of any one of examples 1 to 7, wherein the anonymous block comprises a data manipulation language (DML) statement containing the graph processing algorithm.

Example 9: The system of any one of examples 1 to 8, wherein the graph processing algorithm includes one or more graph processing functions including subgraph, inverse graph, in-degree, out-degree, incoming edges, outgoing edges, neighbors, is-reachable, shortest path, shortest path one to all, k shortest paths, strongly connected components, depth first traversal, and breadth first traversal.

Example 10: The system of any one of examples 1 to 9, wherein the anonymous block is compiled a single time but executed a first time based on a first value of an input parameter provided at execution and a second time based on a second value of the input parameter provided at execution.

Example 11: A computer-implemented method, comprising: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

Example 12: The method of example 11, wherein the anonymous block is defined to include one or more input parameters, and wherein each input parameter is initialized with a scalar expression or a prepared parameter whose value is provided at an execution time of the anonymous block.

Example 13: The method of any one of examples 11 to 12, wherein the anonymous block is further defined to include one or more output parameters, and wherein each output parameter is initialized as a prepared parameter whose value is dependent on the executing of the anonymous block.

Example 14: The method of any one of examples 11 to 13, wherein at least one input parameter or output parameter of the anonymous block is defined to have a structured query language (SQL) data type comprising an integer, a bigint, a double, a Boolean, an nvarchar, or a timestamp.

Example 15: The method of any one of examples 11 to 14, wherein at least one input parameter or output parameter of the anonymous block is defined as a table parameter including one or more columns, and wherein each column may be defined to have a structured query language (SQL) data type comprising an integer, a bigint, a double, a Boolean, an nvarchar, or a timestamp.

Example 16: The method of any one of examples 11 to 15, further comprising: determining that an end user associated with the client device is authorized to access one or more graph workspaces used by the anonymous block to perform the graph processing algorithm; and in response to determining that the end user associated with the client device is authorized to access the one or more graph workspaces, executing the graph processing algorithm included in the anonymous block.

Example 17: The method of example 16, further comprising: generating, for display at the client device, an error message in response to determining that the end user associated with the client device is not authorized to access the one or more graph workspaces used by the anonymous block to perform the graph processing algorithm.

Example 18: The method of any one of examples 11 to 17, wherein the anonymous block comprises a data manipulation language (DML) statement containing the graph processing algorithm.

Example 19: The method of any one of examples 11 to 18, wherein the anonymous block is compiled a single time but executed a first time based on a first value of an input parameter provided at execution and a second time based on a second value of the input parameter provided at execution.

Example 20: A non-transitory computer readable medium storing instructions, which when executed by at least one data processor, result in operations comprising: receiving, from a client device, a graph processing algorithm defined as a part of an anonymous block; compiling the anonymous block; and executing, on at least a portion of a graph data stored in a database, the graph processing algorithm included in the anonymous block, the anonymous block being compiled and executed without generating a database object corresponding to the anonymous block at the database.

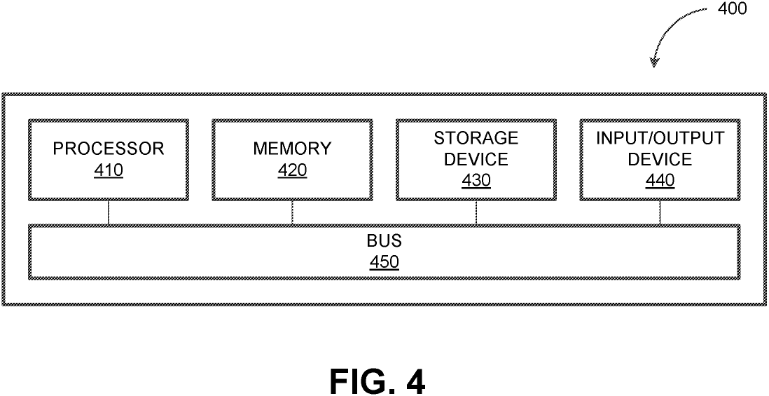

FIG. 4 depicts a block diagram illustrating an example of a computing system 400 consistent with implementations of the current subject matter. Referring to FIGS. 1-4, the computing system 400 can be used to implement the database management system 110 and/or any components therein.

As shown in FIG. 4, the computing system 400 can include a processor 410, a memory 420, a storage device 430, and an input/output device 440. The processor 410, the memory 420, the storage device 430, and the input/output device 440 can be interconnected via a system bus 450. The processor 410 is capable of processing instructions for execution within the computing system 400. Such executed instructions can implement one or more components of, for example, the database management system 110. In some example embodiments, the processor 410 can be a single-threaded processor. Alternately, the processor 410 can be a multi-threaded processor. The processor 410 is capable of processing instructions stored in the memory 420 and/or on the storage device 430 to display graphical information for a user interface provided via the input/output device 440.

The memory 420 is a computer readable medium such as volatile or nonvolatile that stores information within the computing system 400. The memory 420 can store data structures representing configuration object databases, for example. The storage device 430 is capable of providing persistent storage for the computing system 400. The storage device 430 can be a solid state drive, a floppy disk device, a hard disk device, an optical disk device, or a tape device, or other suitable persistent storage means. The input/output device 440 provides input/output operations for the computing system 400. In some example embodiments, the input/output device 440 includes a keyboard and/or pointing device. In various implementations, the input/output device 440 includes a display unit for displaying graphical user interfaces.

According to some example embodiments, the input/output device 440 can provide input/output operations for a network device. For example, the input/output device 440 can include Ethernet ports or other networking ports to communicate with one or more wired and/or wireless networks (e.g., a local area network (LAN), a wide area network (WAN), the Internet).

In some example embodiments, the computing system 400 can be used to execute various interactive computer software applications that can be used for organization, analysis and/or storage of data in various formats. Alternatively, the computing system 400 can be used to execute any type of software applications. These applications can be used to perform various functionalities, e.g., planning functionalities (e.g., generating, managing, editing of spreadsheet documents, word processing documents, and/or any other objects, etc.), computing functionalities, communications functionalities, etc. The applications can include various add-in functionalities or can be standalone computing products and/or functionalities. Upon activation within the applications, the functionalities can be used to generate the user interface provided via the input/output device 440. The user interface can be generated and presented to a user by the computing system 400 (e.g., on a computer screen monitor, etc.).

One or more aspects or features of the subject matter described herein can be realized in digital electronic circuitry, integrated circuitry, specially designed ASICs, field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively or additionally store such machine instructions in a transient manner, such as for example, as would a processor cache or other random query memory associated with one or more physical processor cores.

To provide for interaction with a user, one or more aspects or features of the subject matter described herein can be implemented on a computer having a display device, such as for example a cathode ray tube (CRT) or a liquid crystal display (LCD) or a light emitting diode (LED) monitor for displaying information to the user and a keyboard and a pointing device, such as for example a mouse or a trackball, by which the user may provide input to the computer. Other kinds of devices can be used to provide for interaction with a user as well. For example, feedback provided to the user can be any form of sensory feedback, such as for example visual feedback, auditory feedback, or tactile feedback; and input from the user may be received in any form, including acoustic, speech, or tactile input. Other possible input devices include touch screens or other touch-sensitive devices such as single or multi-point resistive or capacitive track pads, voice recognition hardware and software, optical scanners, optical pointers, digital image capture devices and associated interpretation software, and the like.

In the descriptions above and in the claims, phrases such as “at least one of” or “one or more of′ may occur followed by a conjunctive list of elements or features. The term “and/or” may also occur in a list of two or more elements or features. Unless otherwise implicitly or explicitly contradicted by the context in which it used, such a phrase is intended to mean any of the listed elements or features individually or any of the recited elements or features in combination with any of the other recited elements or features. For example, the phrases “at least one of A and B;” “one or more of A and B;” and “A and/or B” are each intended to mean “A alone, B alone, or A and B together.” A similar interpretation is also intended for lists including three or more items. For example, the phrases “at least one of A, B, and C;” “one or more of A, B, and C;” and “A, B, and/or C” are each intended to mean “A alone, B alone, C alone, A and B together, A and C together, B and C together, or A and B and C together.” Use of the term “based on,” above and in the claims is intended to mean, “based at least in part on,” such that an unrecited feature or element is also permissible.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

What is claimed is:

1. A system, comprising:
at least one data processor; and
at least one memory storing instructions which, when executed by the at least one data processor, result in operations comprising:
receiving, from a client device, a graph processing algorithm defined as a part of an anonymous block;
compiling the anonymous block; and
executing, on at least a portion of a graph data stored in a database, the graph processing algorithm included in the anonymous block, the anonymous block being compiled and executed without generating a database object corresponding to the anonymous block at the database.

2. The system of claim 1, wherein the anonymous block is defined to include one or more input parameters, and wherein each input parameter is initialized with a scalar expression or a prepared parameter whose value is provided at an execution time of the anonymous block.

3. The system of claim 1, wherein the anonymous block is further defined to include one or more output parameters, and wherein each output parameter is initialized as a prepared parameter whose value is dependent on the executing of the anonymous block.

4. The system of claim 1, wherein at least one input parameter or output parameter of the anonymous block is defined to have a structured query language (SQL) data type comprising an integer, a bigint, a double, a Boolean, an nvarchar, or a timestamp.

5. The system of claim 1, wherein at least one input parameter or output parameter of the anonymous block is defined as a table parameter including one or more columns, and wherein each column may be defined to have a structured query language (SQL) data type comprising an integer, a bigint, a double, a Boolean, an nvarchar, or a timestamp.

6. The system of claim 1, wherein the operations further comprise:
determining that an end user associated with the client device is authorized to access one or more graph workspaces used by the anonymous block to perform the graph processing algorithm; and
in response to determining that the end user associated with the client device is authorized to access the one or more graph workspaces, executing the graph processing algorithm included in the anonymous block.

7. The system of claim 6, wherein the operations further comprise:
generating, for display at the client device, an error message in response to determining that the end user associated with the client device is not authorized to access the one or more graph workspaces used by the anonymous block to perform the graph processing algorithm.

8. The system of claim 1, wherein the anonymous block comprises a data manipulation language (DML) statement containing the graph processing algorithm.

9. The system of claim 1, wherein the graph processing algorithm includes one or more graph processing functions including subgraph, inverse graph, in-degree, out-degree, incoming edges, outgoing edges, neighbors, is-reachable, shortest path, shortest path one to all, k shortest paths, strongly connected components, depth first traversal, and breadth first traversal.

10. The system of claim 1, wherein the anonymous block is compiled a single time but executed a first time based on a first value of an input parameter provided at execution and a second time based on a second value of the input parameter provided at execution.

11. A computer-implemented method, comprising:
receiving, from a client device, a graph processing algorithm defined as a part of an anonymous block;
compiling the anonymous block; and
executing, on at least a portion of a graph data stored in a database, the graph processing algorithm included in the anonymous block, the anonymous block being compiled and executed without generating a database object corresponding to the anonymous block at the database.

12. The method of claim 11, wherein the anonymous block is defined to include one or more input parameters, and wherein each input parameter is are initialized with a scalar expression or a prepared parameter whose value is provided at an execution time of the anonymous block.

13. The method of claim 11, wherein the anonymous block is further defined to include one or more output parameters, and wherein each output parameter is initialized as a prepared parameter whose value is dependent on the executing of the anonymous block.

14. The method of claim 11, wherein at least one input parameter or output parameter of the anonymous block is defined to have a structured query language (SQL) data type comprising an integer, a bigint, a double, a Boolean, an nvarchar, or a timestamp.

15. The method of claim 11, wherein at least one input parameter or output parameter of the anonymous block is defined as a table parameter including one or more columns each of which having a structured query language (SQL) data type comprising an integer, a bigint, a double, a Boolean, an nvarchar, or a timestamp.

16. The method of claim 11, further comprising:
determining that an end user associated with the client device is authorized to access one or more graph workspaces used by the anonymous block to perform the graph processing algorithm; and
in response to determining that the end user associated with the client device is authorized to access the one or more graph workspaces, executing the graph processing algorithm included in the anonymous block.

17. The method of claim 16, further comprising:
generating, for display at the client device, an error message in response to determining that the end user associated with the client device is not authorized to access the one or more graph workspaces used by the anonymous block to perform the graph processing algorithm.

18. The method of claim 11, wherein the anonymous block comprises a data manipulation language (DML) statement containing the graph processing algorithm.

19. The method of claim 11, wherein the anonymous block is compiled a single time but executed a first time based on a first value of an input parameter provided at execution and a second time based on a second value of the input parameter provided at execution.

20. A non-transitory computer readable medium storing instructions, which when executed by at least one data processor, result in operations comprising:
receiving, from a client device, a graph processing algorithm defined as a part of an anonymous block;
compiling the anonymous block; and
executing, on at least a portion of a graph data stored in a database, the graph processing algorithm included in the anonymous block, the anonymous block being compiled and executed without generating a database object corresponding to the anonymous block at the database.
